(19) United States
(12) Patent Application Publication
(10) Pub. No.: US 2012/0070116 A1
(43) Pub. Date: Mar. 22, 2012

(54) OPTICAL WAVEGUIDE FOR TOUCH PANEL

(75) Inventor: Toru Mizutani, Osaka (JP)

(73) Assignee: NITTO DENKO CORPORATION, Osaka (JP)

(21) Appl. No.: 13/225,042

(22) Filed: Sep. 2, 2011

(30) Foreign Application Priority Data
Sep. 21, 2010 (JP) 2010-210783

(51) Int. Cl. G02B 6/26

(52) U.S. Cl. 385/31

(57) ABSTRACT

An optical waveguide for a touch panel is provided which is not deteriorated in quality and which decreases or eliminates an undetectable region, even when increased in size. The optical waveguide is configured to be disposed along the periphery of a display screen of a display of a touch panel. The optical waveguide includes light-emitting optical waveguide sections, and light-receiving optical waveguide sections. At least one of the light-emitting optical waveguide sections and at least one of the light-receiving optical waveguide sections are joined together in an alternating pattern along one edge of the display screen. The light-emitting optical waveguide sections and the light-receiving optical waveguide sections are opposed to each other, with the screen therebetween.

### BACKGROUND OF THE INVENTION

1. Field of the Invention

The present invention relates to an optical waveguide for a touch panel which is used as a detection means for detecting a finger touch position and the like in a touch panel.

2. Description of the Related Art

A touch panel is an input device for operating an apparatus by directly touching a display screen of a liquid crystal display and the like with a finger, a purpose-built stylus and the like. The touch panel includes a display that displays operation details and the like, and a detection means that detects the position (coordinates) of a portion of the display screen of the display touched with the finger and the like. Information indicating the touch position detected by the detection means is sent in the form of a signal to the apparatus, which in turn performs an operation and the like displayed on the touch position. Examples of the apparatus employing such a touch panel include ATMs in banking facilities, ticket vending machines in stations, and portable game machines.

A detection means employing an optical waveguide has been proposed as the detection means that detects the finger touch position and the like in the aforementioned touch panel, as disclosed in, for example, Japanese Published Patent Application No. 2008-203431. FIG. 7 is a plan view of the touch panel. Specifically, as shown in FIG. 7, the touch panel includes two L-shaped optical waveguide sections A₀ and B₀ provided along the periphery of a display screen of a rectangular display as seen in plan view. One of the two L-shaped optical waveguide sections opposed to each other with the screen therebetween is a light-emitting optical waveguide section A₀, and the other thereof is a light-receiving optical waveguide section B₀. A light-emitting element 5 is connected to an edge of the light-emitting optical waveguide section A₀, and a light-receiving element 6 is connected to an edge of the light-receiving optical waveguide section B₀. In FIG. 7, the reference character 30A designates light-emitting cores, and 30B designates light-receiving cores, both indicated by broken lines. The thickness of the broken lines indicates the thickness of the cores 30A and 30B. Also, the number of cores 30A and 30B are shown as abbreviated in FIG. 7.

A light beam emitted from the light-emitting element 5 is divided into multiple light beams by the cores 30A of the light-emitting optical waveguide section A₀. The multiple light beams S₀ parallel to the display screen of the display are emitted from the distal ends of the cores 30A of the light-emitting optical waveguide section A₀ toward the other side of the display screen. The distal ends of the cores 30B of the light-receiving optical waveguide section B₀ receive the emitted light beams S₀. These optical waveguide sections A₀ and B₀ cause the emitted light beams S₀ to travel in a lattice form over the display screen of the display. When a portion of the display screen of the display is touched with a finger in this state, the finger blocks some of the emitted light beams S₀. The light-receiving element 6 connected to the light-receiving optical waveguide section B₀ senses a light blocked portion to thereby detect the position (coordinates) of the portion touched with the finger.

There has been a need to increase the size of the display screen of the display of the aforementioned touch panel. To meet the need, it is necessary to increase the size of the optical waveguide sections for the touch panel (to increase the length of the optical waveguide sections A₀ and B₀).

However, a photolithographic process is generally required for the production of the optical waveguide sections A₀ and B₀, and the range of exposure (a range in which uniform exposure can be performed) is limited by an exposure system for use in the photolithographic process. Thus, the length of the optical waveguide sections A₀ and B₀ produced at a time is also limited (in general, a maximum of approximately 30 cm).

To produce the optical waveguide sections A₀ and B₀ having a length exceeding the aforementioned exposure range, it is contemplated to use an exposure system having a wide (long) exposure range or to join a plurality of optical waveguide sections of the same type having the conventional length (either a plurality of light-emitting optical waveguide sections A₀ or a plurality of light-receiving optical waveguide sections B₀) together.

However, the use of an exposure system having a wide (long) exposure range involves the increase in the size of the exposure system to present a problem in space on the manufacturing floor. Additionally, the increase in the size of the exposure system makes it difficult to provide an entirely uniform exposure intensity, which might result in quality deterioration. On the other hand, when the optical waveguide sections A₀ or the optical waveguide sections B₀ which are of the same type and have the conventional length are joined together, the optical waveguide sections A₀ and B₀ have end portions M in which cores 30A and 30B are not formed due to manufacturing reasons of the optical waveguide sections A₀ and B₀, as shown in FIG. 8 which is an enlarged plan view of junctions of the optical waveguide sections A₀ and B₀. The end surfaces of such end portions M are joined to each other. This gives rise to a wide region (shaded in FIG. 8) in which no light beams travel over the display screen of the display. In the region N in which the light beams S₀ do not travel, a finger touch position and the like cannot be detected. In general, the light beams S₀ emitted from the light-emitting optical waveguide sections A₀ diverge in a horizontal direction (along a plane parallel to the display screen), as shown in FIG. 8. In FIG. 8, the divergence of the light beams S₀ is shown in exaggeration for the sake of easier understanding, and the distance between the light-emitting optical waveguide sections A₀ and the light-receiving optical waveguide sections B₀ is shown as shorter.

### SUMMARY OF THE INVENTION

In view of the foregoing, it is therefore an object of the present invention to provide an optical waveguide for a touch panel which is not deteriorated in quality and which decreases or eliminates an undetectable region, even when increased in size.

To accomplish the aforementioned object, the present invention is intended for an optical waveguide for a touch panel, the optical waveguide being configured to be disposed along the periphery of a display screen of a display of a touch panel. The optical waveguide comprises: a plurality of light-emitting optical waveguide sections; and a plurality of light-receiving optical waveguide sections, at least one of the light-emitting optical waveguide sections and at least one of the light-receiving optical waveguide sections being joined together in an alternating pattern along one edge of the display screen, the light-emitting optical waveguide sections and the light-receiving optical waveguide sections being opposed to each other, with the screen therebetween.

In the optical waveguide for a touch panel according to the present invention, at least one of the light-emitting optical waveguide sections and at least one of the light-receiving optical waveguide sections are joined together in an alternating pattern along one edge of the display screen of the display of the touch panel, and the light-emitting optical waveguide sections and the light-receiving optical waveguide sections are opposed to each other, with the screen therebetween. Such a characteristic arrangement of the light-emitting optical waveguide sections and the light-receiving optical waveguide sections allows a region in which no light beams travel over the display screen to be decreased or eliminated (with reference to FIG. 4) in consideration of the horizontal divergence (divergence along a plane parallel to the display screen) of light beams emitted from the light-emitting optical waveguide sections. As a result, an undetectable region is decreased or eliminated. Specifically, although cores are not provided in end portions of two optical waveguide sections joined together as described above due to manufacturing reasons of the optical waveguide, the undetectable region is decreased or eliminated by the aforementioned characteristic arrangement of the light-emitting and light-receiving optical waveguide sections. Additionally, optical waveguide sections produced in an exposure range possessed by a typical exposure system without much difficulty and having conventional lengths may be used as the optical waveguide sections joined together as described above. In other words, the optical waveguide, which is manufactured using a uniform exposure intensity, is not deteriorated in quality.

Preferably, the light-receiving optical waveguide sections are longer than the light-emitting optical waveguide sections opposed to the light-receiving optical waveguide sections, respectively. In such a case, the light-receiving region of the light-receiving optical waveguide sections is increased in size. Thus, the light-receiving optical waveguide sections are able to receive light beams emitted from end portions of the light-emitting optical waveguide sections in consideration of the horizontal divergence (divergence along a plane parallel to the display screen) of the light beams emitted from the light-emitting optical waveguide sections. Therefore, a finger touch position or the like is detected with higher reliability in a touch panel.

Preferably, the light-receiving optical waveguide sections are equal in length to the light-emitting optical waveguide sections opposed to the light-receiving optical waveguide sections, respectively. This facilitates the setting of the size of the optical waveguide for a touch panel according to the present invention.

### BRIEF DESCRIPTION OF THE DRAWINGS

FIG. 1 is a plan view schematically showing an optical waveguide for a touch panel according to a first preferred embodiment of the present invention.

FIG. 2 is a transverse sectional view schematically showing the optical waveguide.

FIG. 3 is a plan view schematically showing optical elements connected to the optical waveguide.

FIG. 4 is a plan view schematically showing light beams traveling between opposed sides of the optical waveguide.

FIG. 5 is a plan view schematically showing an optical waveguide for a touch panel according to a second preferred embodiment of the present invention.

FIG. 6 is a plan view schematically showing an optical waveguide for a touch panel according to a third preferred embodiment of the present invention.

FIG. 7 is a plan view schematically showing a conventional optical waveguide for a touch panel.

FIG. 8 is a plan view schematically showing light beams traveling between opposed sides of a conventional touch panel.

### DETAILED DESCRIPTION OF THE INVENTION

Preferred embodiments according to the present invention will now be described in detail with reference to the drawings.

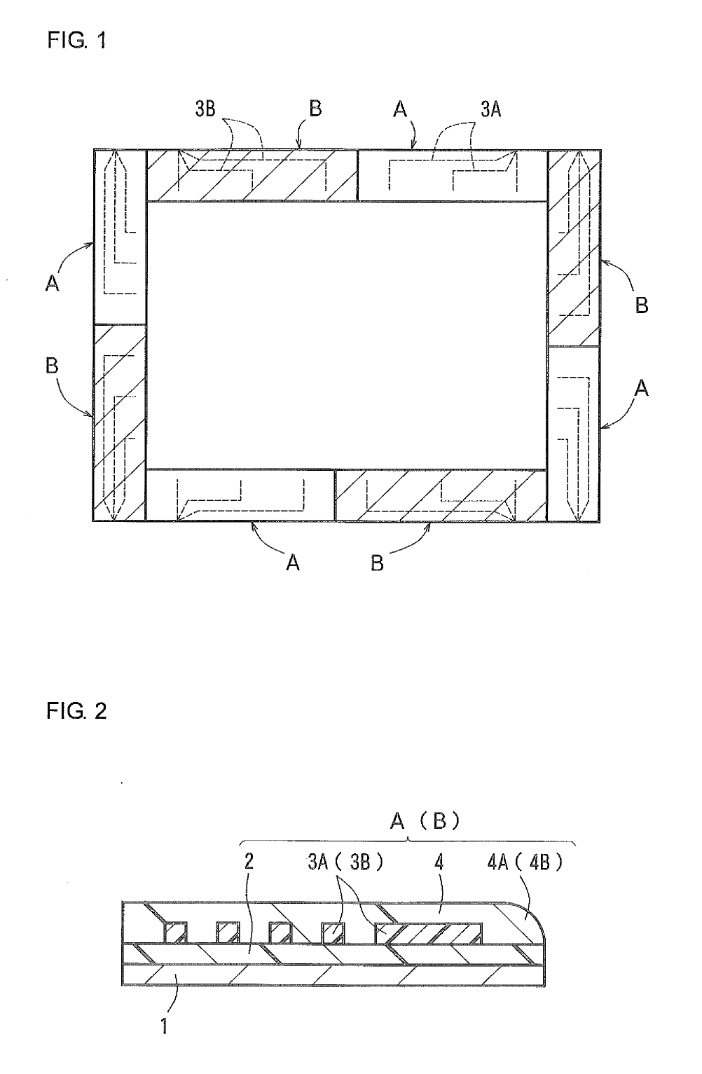

FIG. 1 is a plan view showing an optical waveguide for a touch panel according to a first preferred embodiment of the present invention. As shown in FIG. 1, the optical waveguide according to the first preferred embodiment is in the form of a rectangular frame as seen in plan view. On the four sides constituting the rectangular frame, light-emitting optical waveguide sections A and light-receiving optical waveguide sections B each having an elongated rectangular configuration are jointed together in an alternating pattern. The light-emitting optical waveguide sections A and the light-receiving optical waveguide sections B are opposed to each other on opposed sides of the frame. In the first preferred embodiment, one of the light-emitting optical waveguide sections A and one of the light-receiving optical waveguide sections B are joined together at each corner of the frame. Also in the first preferred embodiment, the light-receiving optical waveguide sections B are longer than the light-emitting optical waveguide sections A. In FIG. 1, the light-receiving optical waveguide sections B are shown as shaded for ease of distinction between the optical waveguide sections A and B.

More specifically, as shown in FIG. 1, the optical waveguide sections A and B include an under cladding layer 2 (with reference to FIG. 2) of an elongated rectangular configuration, multiple cores 3A and 3B formed on a surface of the under cladding layer 2 and having a predetermined pattern, and an over cladding layer 4 formed on the surface of the under cladding layer 2 so as to cover the cores 3A and 3B. The cores 3A and 3B are patterned to extend from predetermined portions corresponding to outer end edges of the frame to portions corresponding to inner end edges of the frame and to be arranged in a parallel, equally spaced relationship. FIG. 2 is a transverse sectional view schematically showing the optical waveguide sections A and B. In the first preferred embodiment, as shown in FIG. 2, edges of the over cladding layer 4 are extended to form lens portions 4A and 4B which cover the end surfaces of the light-emitting and light-receiving cores 3A and 3B lying at inner end edges of the frame. The lens portions 4A and 4B have lens surfaces that are arcuately curved surface as seen in vertical sectional view. Since these components of the light-emitting and light-receiving optical waveguide sections A and B (i.e., the cores 3A and 3B, and the lens portions 4A and 4B) are identical in structure with each other, the light-emitting and light-receiving optical waveguide sections A and B are shown by the same drawing in FIG. 2.

In FIG. 1, the cores 3A and 3B are indicated by broken lines, and the thickness of the broken lines indicates the thickness of the cores 3A and 3B. Also, the number of cores 3A and 3B are shown as abbreviated in FIG. 1. In FIG. 2, the reference numeral 1 designates a substrate which supports the optical waveguide sections A and B.

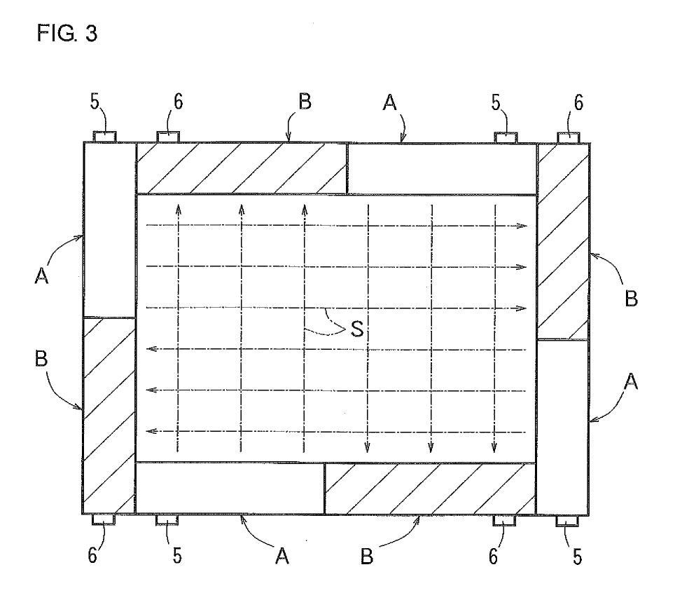

When the optical waveguide in the form of a rectangular frame is used for a touch panel, a light-emitting element 5 is connected to a predetermined portion of an edge of each of the light-emitting optical waveguide sections A (a proximal end portion of the multiple cores 3A with reference to FIG. 1) which corresponds to an outer end edge of the frame, and a light-receiving element 6 is connected to a predetermined portion of an edge of each of the light-receiving optical waveguide sections B (a proximal end portion of the multiple cores 3B with reference to FIG. 1) which corresponds to an outer end edge of the frame, as shown in FIG. 3. Then, the light-emitting optical waveguide sections A connected to the respective light-emitting elements 5 and the light-receiving optical waveguide sections B connected to the respective light-receiving elements 6 are disposed along the rectangular periphery of a display screen of a rectangular display of a touch panel so as to surround the display screen.

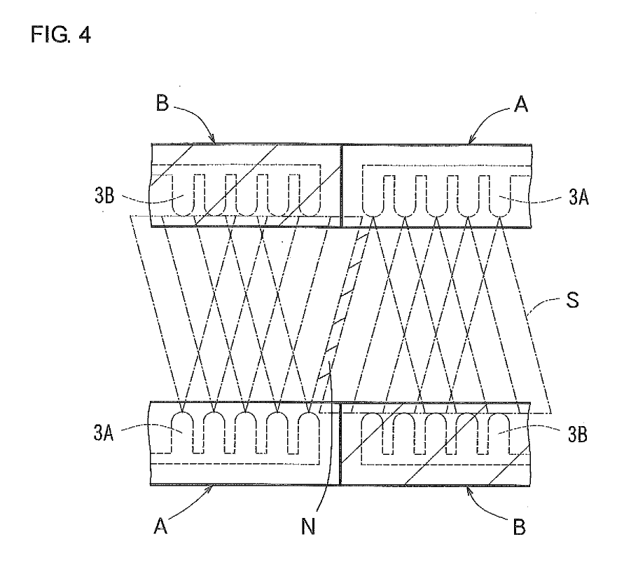

FIG. 4 is a plan view showing light beams traveling between opposed sides of the optical waveguide. As shown in FIG. 4, light beams S emitted from the distal end surfaces of the cores 3A of the light-emitting optical waveguide sections A reach the distal end surfaces of the cores 3B of the light-receiving optical waveguide sections B opposed to the respective light-emitting optical waveguide sections A, while diverging in a horizontal direction (along a plane parallel to the display screen). On the four sides constituting the frame, the light-emitting optical waveguide sections A and the light-receiving optical waveguide sections B are jointed together. Thus, a region N (shaded in FIG. 4) in which no light beams S travel over the display screen is very narrow or does not exist. This enables a finger touch position or the like to be detected with reliability. In particular, the light-receiving optical waveguide sections B are longer than the light-emitting optical waveguide sections A in the first preferred embodiment. This allows the light-receiving optical waveguide sections B to receive the light beams S emitted from end portions of the light-emitting optical waveguide sections A, thereby improving the reliability of the detection. In FIG. 4, for the sake of easier understanding, the divergence of the light beams S is shown in exaggeration, and the distance between the light-emitting optical waveguide sections A and the light-receiving optical waveguide sections B is shown as shorter.

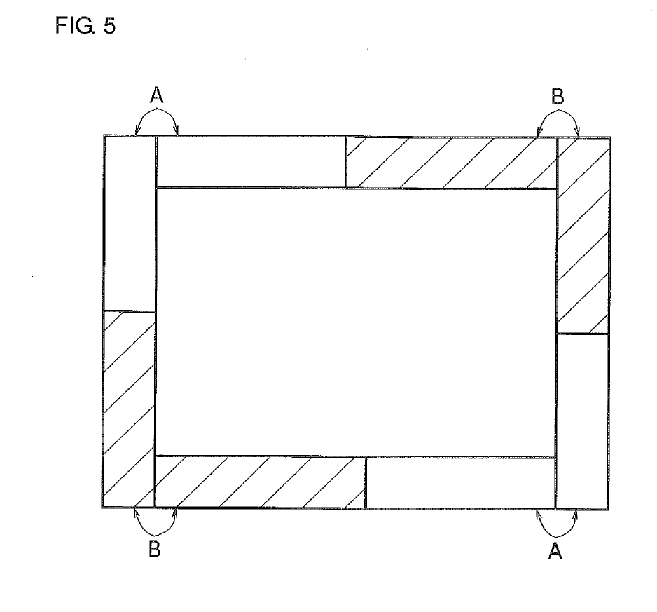

FIG. 5 is a plan view showing an optical waveguide for a touch panel according to a second preferred embodiment of the present invention. As shown in FIG. 5, the optical waveguide according to the second preferred embodiment is configured such that either two light-emitting optical waveguide sections A or two light-receiving optical waveguide sections B are jointed together at each corner of the rectangular frame. Other parts of the second preferred embodiment are similar to those of the first preferred embodiment. The second preferred embodiment produces functions and effects similar to those of the first preferred embodiment.

In the second preferred embodiment, either the two optical waveguide sections A or the two optical waveguide sections B joined at each corner may be integrated together to form an L-shaped optical waveguide section A or B.

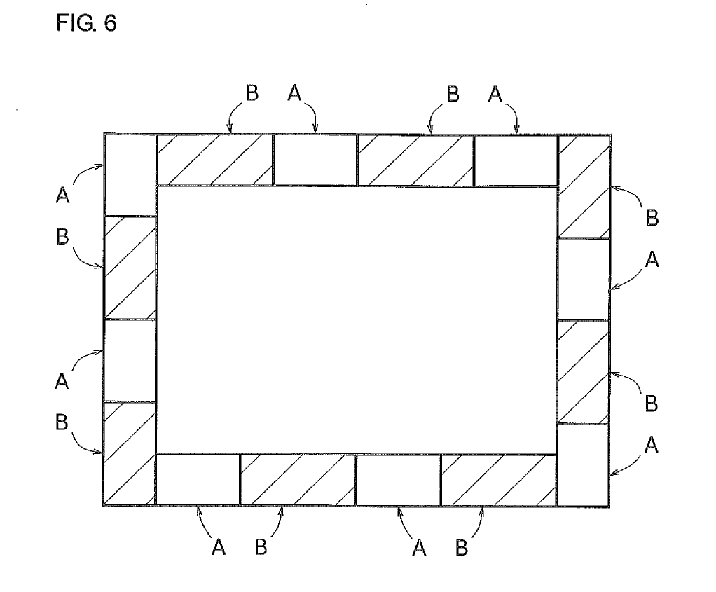

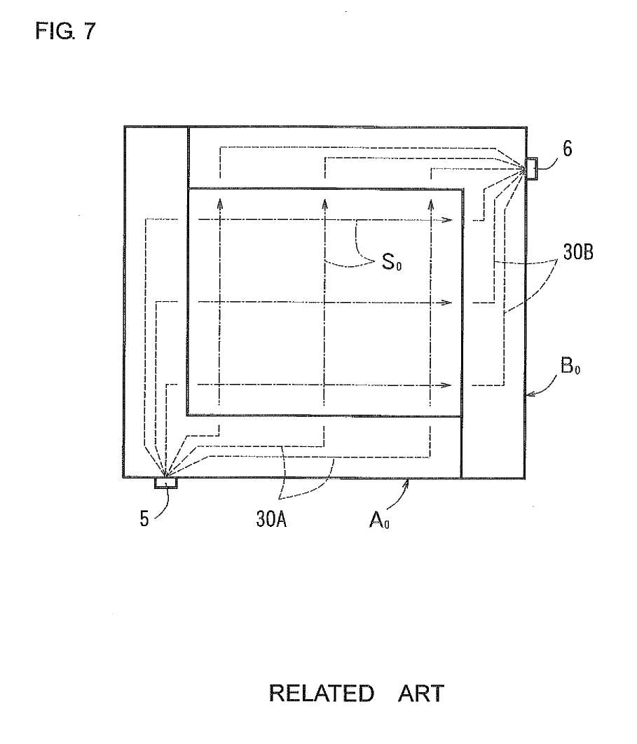

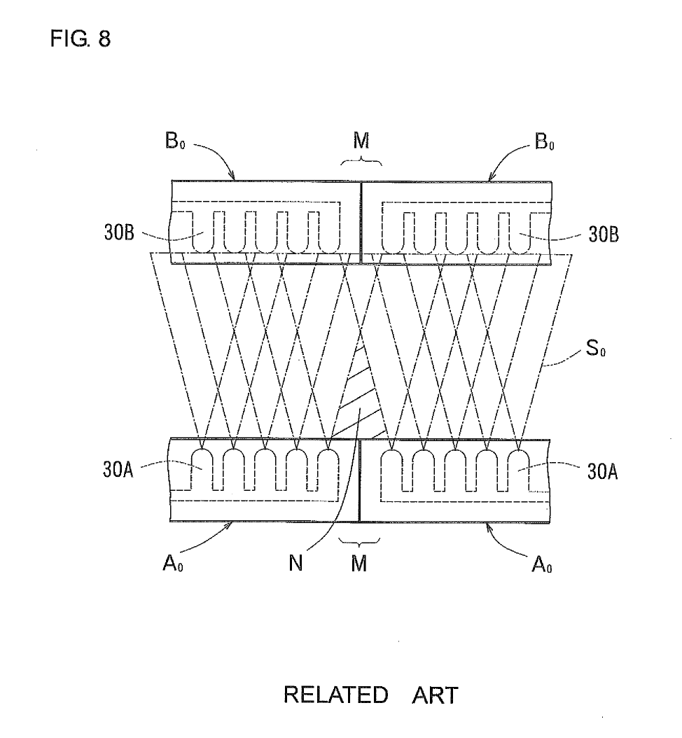

FIG. 6 is a plan view showing an optical waveguide for a touch panel according to a third preferred embodiment of the present invention. The optical waveguide according to the third preferred embodiment is of a greater size. On each of the four sides constituting the rectangular frame, multiple light-emitting optical waveguide sections A and multiple light-receiving optical waveguide sections B (in FIG. 6, two light-emitting optical waveguide sections A and two light-receiving optical waveguide sections B) are jointed together in an alternating pattern, as shown in FIG. 6. Other parts of the third preferred embodiment are similar to those of the first preferred embodiment. The third preferred embodiment produces functions and effects similar to those of the first preferred embodiment.

In the preferred embodiments described above, the light-receiving optical waveguide sections B are longer than the light-emitting optical waveguide sections A. However, the optical waveguide sections A and B may be equal in length.

For the manufacture of the optical waveguides according to the first to third preferred embodiments, the optical waveguide sections A and B produced in an exposure range possessed by a typical exposure system without much difficulty and having conventional lengths are bonded and joined onto a substrate having the shape of a frame so as to be disposed in the arrangements of the first to third preferred embodiments.

If a defect occurs, for example, in one of the optical waveguide sections A and B in the optical waveguide produced by joining the optical waveguide sections A and B having the conventional lengths together in this manner, it is only necessary to replace the one optical waveguide section A or B having the defect, but the entire optical waveguide need not be discarded. This reduces waste of materials for the formation of the optical waveguide sections A and B. On the other hand, when a defect occurs in a long optical waveguide produced at a time, it is necessary to discard the entire long optical waveguide. This results in much waste of materials for the formation of the optical waveguide.

Next, inventive examples of the present invention will be described in conjunction with a comparative example. It should be noted that the present invention is not limited to the inventive examples.

### EXAMPLES

### Inventive Example 1

An optical waveguide for a touch panel corresponding to a display having a rectangular display screen measuring 15 inches (381.0 mm) in size was produced. Each of the opposed long sides of the optical waveguide was formed by joining a light-emitting optical waveguide section (151 mm in length) and a light-receiving optical waveguide section (154.0 mm in length) together. Each of the opposed short sides of the optical waveguide was formed by joining a light-emitting optical waveguide section (113.0 mm in length) and a light-receiving optical waveguide section (116.0 mm in length) together.

### Inventive Example 2

An optical waveguide for a touch panel corresponding to a display having a rectangular display screen measuring 15 inches (381.0 mm) in size was produced. Each of the opposed long sides of the optical waveguide was formed by joining a light-emitting optical waveguide section and a light-receiving optical waveguide section which were equal in length (152.5 mm) together. Each of the opposed short sides of the optical waveguide was formed by joining a light-emitting optical waveguide section and a light-receiving optical waveguide section which were equal in length (114.5 mm) together.

### Comparative Example

An optical waveguide for a touch panel corresponding to a display having a rectangular display screen measuring 15 inches (381.0 mm) in size was produced. One of the long sides of the optical waveguide was formed by joining light-emitting optical waveguide sections which were equal in length (152.5 mm) together, and the other long side of the optical waveguide opposed to the one long side was formed by joining light-receiving optical waveguide sections which were equal in length (152.5 mm) together. One of the short sides of the optical waveguide was formed by joining light-emitting optical waveguide sections which were equal in length (114.5 mm) together, and the other short side of the optical waveguide opposed to the one short side was formed by joining light-receiving optical waveguide sections which were equal in length (114.5 mm) together.

### Evaluation of Detection

In the optical waveguides in Inventive Examples 1 and 2 and in Comparative Example, a light-emitting element (a VCSEL available from Optowell Co., Ltd.) for emitting light beams with a wavelength of 850 nm was connected to an edge of each of the light-emitting optical waveguide sections, and a light-receiving element (a CMOS linear sensor array available from TAOS Inc.) was connected to an edge of each of the light-receiving optical waveguide sections. Light beams were caused to travel in a lattice form within the frame of each of the optical waveguides. In that state, a cylindrical object having a diameter of 3 mm was moved over the display screen.

The result was that the cylindrical object was detected at any position over the display screen in Inventive Examples 1 and 2. In Comparative Example, however, the cylindrical object was not detected in a central part of the display screen, but was detected in a position 3 mm apart from the central part.

The aforementioned result shows that the optical waveguides (in Inventive Examples 1 and 2) in which the light-emitting optical waveguide sections and the light-receiving optical waveguide sections are joined together in an alternating pattern and in which the light-emitting optical waveguide sections and the light-receiving optical waveguide sections are opposed to each other with the screen therebetween are excellent in detectability.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

### INDUSTRIAL APPLICABILITY

An optical waveguide for a touch panel according to the present invention is applicable to an optical waveguide for use as a detection means (a position sensor) for detecting a finger touch position and the like in a touch panel.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

What is claimed is:

1. An optical waveguide for a touch panel, the optical waveguide being configured to be disposed along the periphery of a display screen of a display of a touch panel, the optical waveguide comprising:
a plurality of light-emitting optical waveguide sections; and
a plurality of light-receiving optical waveguide sections,
at least one of the light-emitting optical waveguide sections and at least one of the light-receiving optical waveguide sections being joined together in an alternating pattern along one edge of the display screen,
the light-emitting optical waveguide sections and the light-receiving optical waveguide sections being opposed to each other, with the screen therebetween.

2. The optical waveguide according to claim 1, wherein, the light-receiving optical waveguide sections are longer than the light-emitting optical waveguide sections opposed to the light-receiving optical waveguide sections, respectively.

3. The optical waveguide according to claim 1, wherein, the light-receiving optical waveguide sections are equal in length to the light-emitting optical waveguide sections opposed to the light-receiving optical waveguide sections, respectively.
